(19) United States
(12) Patent Application Publication
(10) Pub. No.: US 2009/0292829 A1
(43) Pub. Date: Nov. 26, 2009

(54) Data processing system and component management method

(75) Inventor: Hiroshi Mizuho, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/453,771

(22) Filed: May 21, 2009

(30) Foreign Application Priority Data
May 22, 2008 (JP) 2008-133783

(51) Int. Cl. G06F 3/00; G06F 13/00

(52) U.S. Cl. 710/11; 710/32

(57) ABSTRACT

A data processing system is provided which includes a plurality of components to perform prescribed processing based on an operation mode, a chain controller to perform control including setting of the operation mode on at least one of the plurality of components, a storage unit to store chain configuration definition information associating at least one of the plurality of components with the chain controller for each prescribed data processing, and a configuration management unit to receive a processing request for the prescribed data processing and form a chain corresponding to the requested data processing based on the chain configuration definition information.

### BACKGROUND

1. Field of the Invention

The present invention relates to a data processing system and a component management method and, particularly, to a data processing system that performs data processing by joining components which operate in a plurality of modes, and a component management method.

2. Description of Related Art

A technique related to development of a software driver of a computer for performing data processing of multimedia or the like is disclosed in Japanese Unexamined Patent Publication No. 10-283195. The technique disclosed therein first regulates the specifications of a pin for connecting software drivers (which are referred to hereinafter simply as drivers) and isolates the drivers into components in units of functions. Further, a control agent sequentially refers to the pin specifications of driver components and determines the optimum connection characteristics. Then, the control agent sequentially connects a plurality of components from a component for reading data to a component for outputting data. Further, the control agent enables implementation of functions such as rendering of multimedia data by the components. Connection and data transmission and reception between driver components are thereby performed in kernel mode, thus allowing optimization of system performance.

Further, the technique disclosed in Japanese Unexamined Patent Publication No. 2006-31261 solves an issue that it is unable to set appropriate timing to activate a proper processing module in the case where a logic module and a processing module are not in one-to-one correspondence, which is the issue in Japanese Unexamined Patent Publication No. 10-283195.

According to Japanese Unexamined Patent Publication No. 2006-31261, an application initializes the configuration of components, issues a LOCK command indicating determination of the configuration, and the connection relationship between a plurality of components is thereby stored in an association management unit. Further, a stream correspondence logical module configuration table that manages a plurality of configurations is prepared, and an application designates only the codec information of a stream to thereby use the configuration.

### SUMMARY

In some fields of application of the system, the configuration of components differs even when implementing the equal multimedia processing function. However, it is often the case in an embedded system or the like that constraints on resources are so strict that only the minimum necessary components can be mounted in each system. Therefore, in the implementation of components, in order to use the same component for a plurality of multimedia processing functions, “mode” is made selectable which is an input parameter of a plurality of initial settings corresponding to the respective multimedia processing functions. This allows the components to switch processing when a mode corresponding to any of the multimedia processing functions is set.

For example, in a processing component of input data, which is moving picture data, a corresponding moving picture compression format should be MPEG2 (Moving Picture Experts Group phase 2)-PS (Program Stream) in the case of DVD (Digital Versatile Disk), and MPEG2-TS (Transport Stream) in the case of DTV (Digital Television). In the processing component of input data, most of processing excluding analysis of a stream recording format can be used in common. Therefore, in order select a moving picture compression format, the two kinds of modes, MPEG2-PS and MPEG2-TS, are prepared. It is thereby possible to use the same component for two processing, inputs of DVD and DTV.

However, the present inventor has found a problem that, in the technique disclosed in Japanese Unexamined Patent Publication No. 2006-31261, it is not assumed to set different modes to each component, and it is thus unable to selectively use processing depending on a combination of the same component with different modes. Therefore, in the technique disclosed in Japanese Unexamined Patent Publication No. 2006-31261, it is necessary to hold information of the mode to be set in the application. Further, in order to perform setting of different modes to the same component, it is necessary to modify the application.

A first exemplary aspect of an embodiment of the present invention is a data processing system including a plurality of components to perform prescribed processing based on an operation mode, a chain controller to perform control including setting of the operation mode on at least one of the plurality of components, a storage unit to store chain configuration definition information associating at least one of the plurality of components with the chain controller for each prescribed data processing, and a configuration management unit to receive a processing request for the prescribed data processing and form a chain corresponding to the requested data processing based on the chain configuration definition information.

A second exemplary aspect of an embodiment of the present invention is a component management method for causing a computer to execute management of a plurality of components to perform prescribed processing based on an operation mode, which includes receiving a processing request for prescribed data processing, reading chain configuration definition information associating at least one of the plurality of components with a chain controller to perform control including setting of the operation mode on at least one of the plurality of components for each prescribed data processing from a storage unit, and managing a configuration by forming a chain corresponding to the processing request for the prescribed data processing based on the chain configuration definition information.

According to the data processing system and the component management method described above, the configuration of a plurality of components to implement prescribed data processing in a set operation mode is prestored in a storage unit as configuration definition information. Then, a configuration management unit forms a chain based on a processing request, so that a chain controller can perform operation mode setting of the plurality of components. It is thereby possible to cause the same component to perform a plurality of different data processing by operating a plurality of components by operation mode setting corresponding to a processing request.

According to the exemplary aspects of an embodiment of the present invention described above, by separating configuration information of a component, among a plurality of components to operate in a set mode, and mode setting information for implementing prescribed data processing from an application, it is possible to improve the portability of the application.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing the overall configuration of a multimedia processing system according to a first exemplary embodiment of the present invention;

FIG. 2 is a view showing an example of configuration definition information according to the first exemplary embodiment of the present invention;

FIG. 3 is a sequence chart of chain formation processing in the multimedia processing system according to the first exemplary embodiment of the present invention;

FIG. 4 is a flowchart of chain formation processing by a chain controller according to the first exemplary embodiment of the present invention;

FIG. 5 is a flowchart of component connection processing by the chain controller according to the first exemplary embodiment of the present invention;

FIG. 6 is a flowchart of component mode setting processing by the chain controller according to the first exemplary embodiment of the present invention;

FIG. 7 is a block diagram showing the overall configuration of a multimedia processing system according to a second exemplary embodiment of the present invention;

FIG. 8 is a view showing an example of configuration definition information according to the second exemplary embodiment of the present invention;

FIG. 9 is a sequence chart of connection termination processing in a multimedia processing system according to a third exemplary embodiment of the present invention;

FIG. 10 is a view showing an example of configuration definition information according to a fourth exemplary embodiment of the present invention;

FIG. 11 is a flowchart of chain exclusive control processing by a configuration management unit according to the fourth exemplary embodiment of the present invention;

FIG. 12 is a block diagram showing the overall configuration of a multimedia processing system according to a fifth exemplary embodiment of the present invention;

FIG. 13 is a view showing an example of configuration definition information according to the fifth exemplary embodiment of the present invention;

FIG. 14 is a flowchart of component exclusive control processing by a configuration management unit according to the fifth exemplary embodiment of the present invention;

FIG. 15 is a sequence chart of component exclusive control processing in the multimedia processing system according to the fifth exemplary embodiment of the present invention;

FIG. 16A is a view showing an example of executability information contained in component state information according to the fifth exemplary embodiment of the present invention; and

FIG. 16B is a view showing an example of the number of concurrent executions and the upper limit of the number of concurrent executions contained in component state information according to the fifth exemplary embodiment of the present invention.

### DETAILED DESCRIPTION OF THE EXEMPLARY EMBODIMENTS

The first, second, third, forth and fifth exemplary embodiments can be combined as desirable by one of ordinary skill in the art.

Embodiments of the present invention are described hereinafter with reference to the drawings. In the drawings, the same elements are denoted by the same reference symbols, and redundant explanation is omitted as appropriate for clarifying explanation.

### First Exemplary Embodiment

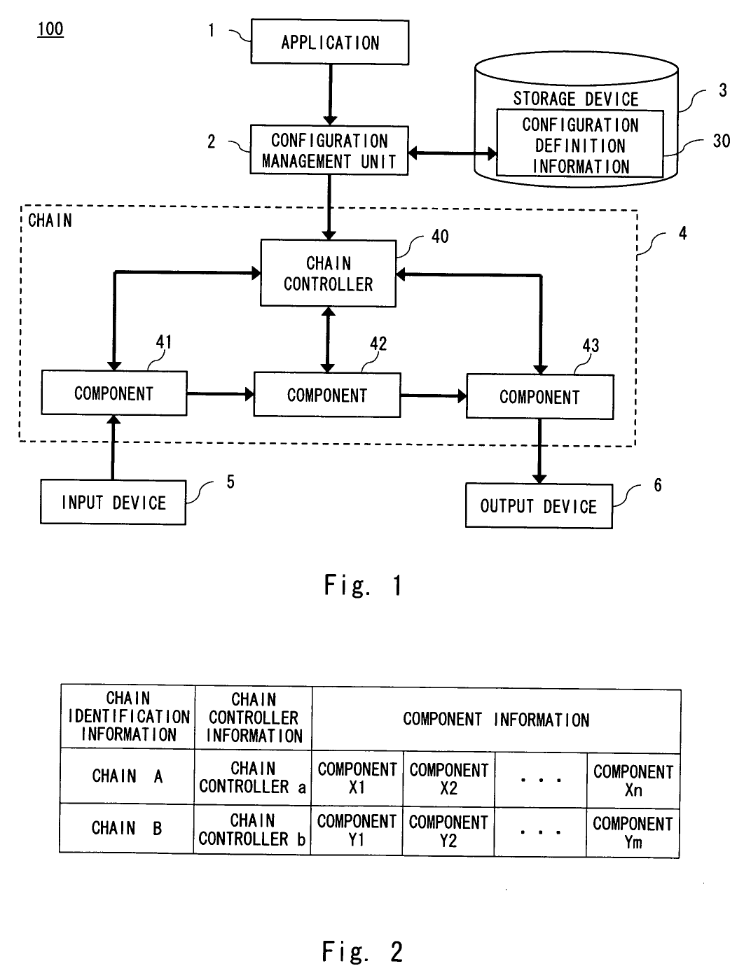

FIG. 1 is a block diagram showing the overall configuration of a multimedia processing system 100 according to a first exemplary embodiment of the present invention. The multimedia processing system 100 is a general-purpose computer system. The multimedia processing system 100 further includes a CPU (Central Processing Unit), RAM (Random Access Memory), ROM (Read Only Memory) and a nonvolatile storage device, which are not shown. The CPU reads and executes an OS (Operating System) stored in the RAM, the ROM or the nonvolatile storage device and an application 1, a configuration management unit 2, a chain controller 40, a component 41, a component 42 and a component 43, which are programs, thereby implementing a multimedia processing function in the multimedia processing system 100. An example of the operation of the multimedia processing system 100 is outputting data which is input from an input device 5 to an output device 6 via the component 41, the component 42 and the component 43 according to an instruction from the application 1. The multimedia processing system 100 is applicable to a dedicated device (a DVD recorder, a TV set etc.) that incorporates a SoC (System-On-a-Chip) integrating an embedded microcomputer and a peripheral function, for example.

The input device 5 is a hardware device for inputting multimedia data. The input device 5 may be a broadcast receiving device, a recording medium playback device or the like, for example, although not limited thereto. The output device 6 is a hardware device for outputting multimedia data. The output device 6 may be a display device, a speaker or the like, for example, although not limited thereto.

The components 41 to 43 are logical software components associated with processing of a certain unit for performing a series of stream data processing in the multimedia processing function to be implemented in the multimedia processing system 100. The series of stream data processing is processing such as data input, data decompression, audio output or the like, for example. Further, the components 41 to 43 include at least one input port and output port and a control interface. The control interface is an interface for receiving various kinds of requests including an instruction for making the component operable, a reference to the specifications of each port, an instruction for executing processing to connect its own input port and an output port of another component, an instruction for executing processing to connect its own output port and an input port of another component and so on.

The components 41 to 43 may be a software driver or the like that supports the function of particular hardware or a software processing module. In this example, the component 41 includes a driver for inputting data from the input device 5. The component 43 includes a driver for outputting data to the output device 6. The component 42 receives data from the component 41, performs prescribed processing and outputs the data to the component 43. The component 42 may be a decompressor, for example.

The components 41 to 43 can switch operations according to an operation mode (which is referred to hereinafter simply as the mode), which is an input parameter of a plurality of initial settings corresponding to a plurality of multimedia processing functions. The components 41 to 43 operate based on the mode which is input from the chain controller 40 through the control interface at the time of initial setting. The mode may be represented by a numerical value or a character string. Further, the components 41 to 43 can perform an operation corresponding to the selected mode by selecting an internal parameter or the like based on the input mode. The modes in the components 41 to 43 may operate by a predetermined value when there is no input.

Examples of modes are described by way of illustration below. For example, the mode of a moving picture compression format may be MPEG2-PS for performing DVD processing or MPEG2-TS for performing DTV processing. The mode of a playback audio may be Japanese or another language such as English, or a main voice or a sub-voice and so on. The mode of the definition of an image may be SD (Standard Definition) used for DVD video processing or HD (High Definition) used for DTV video processing.

Further, although each of the components 41 and 43 is associated with one hardware in this example, the present invention is not limited thereto. Specifically, the components 41 and 43 may perform input and output with a plurality of hardware. Alternatively, the components 41 and 43 may be configured such that a plurality of components are associated with one hardware.

The chain controller 40 is software that controls the components 41 to 43 so as to implement the multimedia processing. The chain controller 40 receives various kinds of instructions from the configuration management unit 2, gives the instruction to the respective control interfaces of the components 41 to 43 and makes the components 41 to 43 operable. At that time, the chain controller 40 allocates resources to the components 41 to 43, connects the components and inputs (sets) the above-described mode. The chain controller 40 performs control including mode setting on at least one of the components 41 to 43.

There is one chain controller 40 corresponding to the intended multimedia processing function. The chain controller 40 performs mode setting for implementing the multimedia processing function to the plurality of components 41 to 43.

For example, the chain controller for playing back a broadcast moving picture and the chain controller for playing back a playback moving picture from a recording medium share the decompressor of compressed moving picture data, the component for moving picture display, audio output and so on. Then, each chain controller selects mode setting of each component, thereby using the same component for different uses.

Further, if a particular multimedia processing function is divided into several pieces to be implemented by a plurality of components, the chain controller 40 performs connection of those components when activating the function. The connection processing between the components includes setting the optimum number and capacity of buffers for stream data according to a necessary data transfer rate in order to transfer the stream data between the components, for example. The connection processing between the components varies by the intended multimedia processing function or the configuration of the component to be connected. Thus, connection processing between the components is performed in each chain controller 40, corresponding to the intended multimedia processing function.

A set of a series of software which implement the multimedia processing function is called a chain. As shown in FIG. 1, a chain 4 includes the components 41 to 43 and the chain controller 40. The chain is composed of at least one component and one chain controller for setting a prescribed mode to the component.

A storage device 3 stores chain configuration definition information, which is configuration definition information 30 shown in FIG. 1, for example, that associates at least one of the plurality of components described above with the chain controller 40 for each prescribed data processing, e.g. each multimedia processing function. The storage device 3 may be a nonvolatile storage device such as a hard disk drive, a magneto-optical disk drive or flash memory, or a volatile storage device such as DRAM (Dynamic Random Access Memory). If the storage device 3 is a volatile storage device, the configuration definition information 30 is stored in another nonvolatile storage device.

The configuration definition information 30 defines the configuration of the chain 4. In this case, the configuration definition information 30 is data in which information for identifying the chain controller 40 and component identification information for identifying each of the components 41 to 43 are associated with chain identification information for identifying the chain 4. The configuration definition information 30 is preferably managed in the form of a structure, a database table, an array made up of a combination of a plurality of character-string constants or the like, for example. FIG. 2 is a view showing an example of the configuration definition information 30 according to the first exemplary embodiment of the present invention. The configuration definition information 30 shown in FIG. 2 indicates that one chain controller and a plurality of different components belong to each of two chains. At least one chain may belong to the configuration definition information 30. Further, the configuration definition information 30 does not necessarily contain the chain identification information described above, and a storage area may be allocated in the storage device 3 for each data processing requested from the application 1.

Referring back to FIG. 1, the application 1 is arbitrary software having a function to instruct the start of the multimedia processing. The application 1 transmits a processing request for data processing to the configuration management unit 2. For example, the application 1 transmits a chain formation instruction which contains chain identification information indicating the type of the multimedia processing function to the configuration management unit 2.

The configuration management unit 2 receives a processing request for prescribed data processing and forms a chain corresponding to the data processing based on the configuration definition information 30. For example, the configuration management unit 2 is software that transmits an instruction to the chain controller 40 and causes the chain controller 40 to activate the components 41 to 43 belonging to the chain 4 to thereby implement the multimedia processing function. Particularly, the configuration management unit 2 receives a chain formation instruction, which is a processing request from the application 1, acquires information of the chain controller 40 corresponding to the chain identification information contained in the chain formation instruction from the configuration definition information 30 stored in the storage device 3 and transmits the chain formation instruction to the chain controller 40.

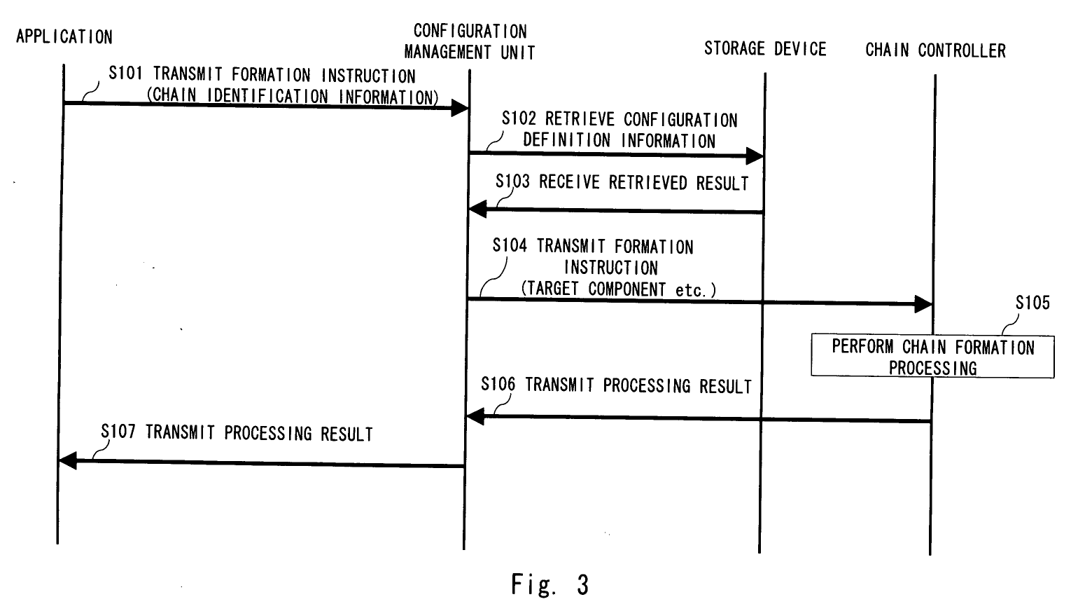

FIG. 3 is a sequence chart of chain formation processing in the multimedia processing system 100 according to the first exemplary embodiment of the present invention.

First, the application 1 transmits a chain formation instruction to the configuration management unit 2 (S101). The chain formation instruction contains chain identification information of the chain 4.

Next, the configuration management unit 2 retrieves the configuration definition information based on the received chain formation instruction (S102). Specifically, the configuration management unit 2 receives the chain formation instruction from the application 1 and extracts chain identification information from the chain formation instruction. Then, the configuration management unit 2 searches the configuration definition information 30 stored in the storage device 3 using the extracted chain identification information as a search key.

Then, the configuration management unit 2 receives the retrieved configuration definition information 30 (S103). Specifically, the configuration management unit 2 receives the configuration definition information 30 containing the chain identification information of the chain 4 and acquires identification information of the chain controller 40 and component identification information of each of the components 41 to 43 which are contained in the configuration definition information 30. The configuration management unit 2 can thereby select the chain controller to which an instruction is to be given.

After that, the configuration management unit 2 transmits a chain formation instruction containing the component identification information to the chain controller selected in the step S103 (S104). The chain controller 40 then performs chain formation processing (S105).

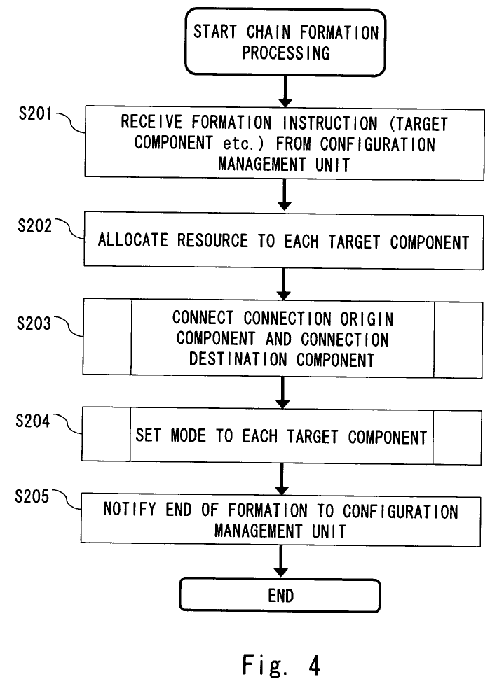

FIG. 4 is a flowchart of chain formation processing by the chain controller according to the first exemplary embodiment of the present invention. First, the chain controller 40 receives a chain formation instruction from the configuration management unit 2 (S201). The chain controller 40 then extracts information of a processing target component from the chain formation instruction.

Next, the chain controller 40 allocates a resource to each target component (S202). Specifically, the chain controller 40 allocates a resource by reserving memory necessary for operation, for example, to each of the components 41 to 43 specified by the component identification information.

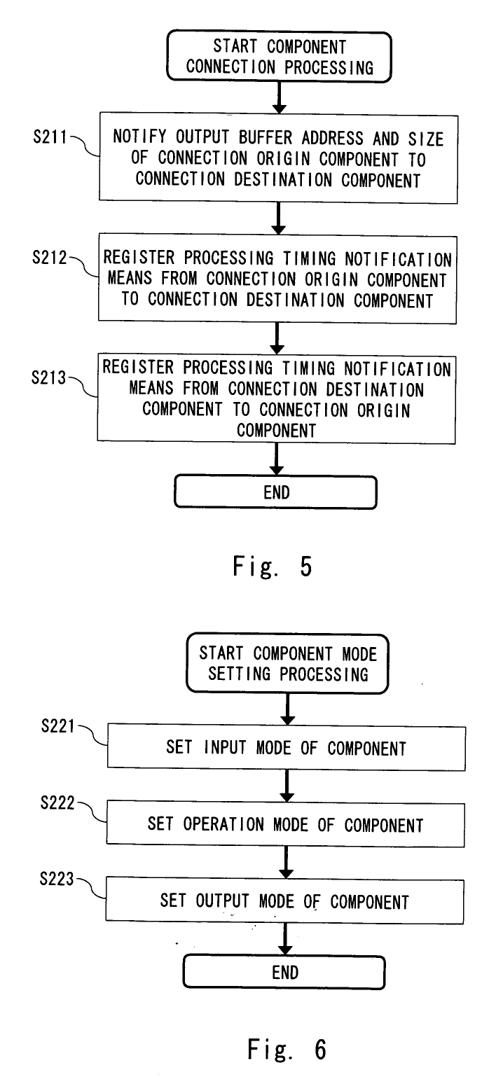

Then, the chain controller 40 connects between a connection origin component and a connection destination component (S203). The chain controller 40 performs processing sequentially on each set of the connection origin component and the connection destination component based on connection relationship information between the components. The detail of processing on each set in the step S203 is described later with reference to FIG. 5.

The connection relationship information is list information that pairs an output port of the connection origin component and an input port of the connection destination component. The connection relationship information may be contained in the chain formation instruction from the configuration management unit 2. In such a case, the connection relationship information is contained beforehand in the configuration definition information 30 in association with the chain identification information. Alternatively, the configuration management unit 2 may determine the sequence of connection of the components by referring to the specifications of the input port and the output port of the components 41 to 43 through the chain controller 40, for example, before the step S104 and thereby generate the connection relationship information. Alternatively, the connection relationship information may be prestored in the chain controller 40.

Then, the chain controller 40 performs mode setting for each target component (S204). The detail of processing on each target component in the step S204 is described later with reference to FIG. 6.

Finally, the chain controller 40 notifies the configuration management unit 2 that the chain formation processing ends (S205).

FIG. 5 is a flowchart of component connection processing by the chain controller 40 according to the first exemplary embodiment of the present invention. An example where the connection origin component is the component 41 and the connection destination component is the component 42 is described hereinafter.

First, the chain controller 40 notifies the output buffer address and size of the connection origin component to the connection destination component (S211). For example, the chain controller 40 acquires the output buffer address and size corresponding to the output port of the component 41 through the control interface of the component 41. Then, the chain controller 40 transmits the output buffer address and size through the control interface of the component 42.

Next, the chain controller 40 registers a processing timing notification means from the connection origin component to the connection destination component (S212). The processing timing notification means may be a function or the like to be called upon completion of filling data into the buffer from the component 41 to the component 42, for example.

Further, the chain controller 40 registers a processing timing notification means from the connection destination component to the connection origin component (S213). The processing timing notification means may be a function or the like to be called upon completion of filling data into the buffer from the component 42 to the component 41, for example.

The processing from the step S211 to the step S213 are the same when the connection origin component is the component 42 and the connection destination component is the component 43.

FIG. 6 is a flowchart of component mode setting processing by the chain controller according to the first exemplary embodiment of the present invention. In the following example, the chain controller 40 performs processing to play back DVD in Japanese. Thus, the chain controller 40 stores information of the modes, which are MPEG2-PS, Japanese and SD, in advance.

First, the chain controller 40 performs setting of the input mode of the component (S221). For example, the chain controller 40 sets MPEG2-PS as the moving picture compression format for the component 41.

Next, the chain controller 40 performs setting of the operation mode of the component (S222). For example, the chain controller 40 sets Japanese as the playback audio for the component 42.

Further, the chain controller 40 performs setting of the output mode of the component (S222). For example, the chain controller 40 sets SD as the definition of videos for the component 43.

Referring back to FIG. 3, the chain controller 40 transmits a result of the above-described chain formation processing back to the configuration management unit 2 (S106). Then, the configuration management unit 2 transmits the result of the chain formation processing back to the application 1 (S107).

In this manner, in the multimedia processing system 100 according to the first exemplary embodiment of the present invention, the chain controller 40 and the components 41 to 43 are prestored in association with the chain 4 as the configuration definition information 30. This enables the chain controller 40 to perform control including setting of the mode of each component in the multimedia processing corresponding to the chain 4. Accordingly, the chain controller 40 is selected based on the chain formation instruction indicating the chain 4, and the chain controller 40 allocates resources to the respective target components and connects the components to allow operation in an appropriate mode, thereby implementing a series of multimedia processing functions.

This eliminates the need to implement the above-described processing in the application 1, and it is thereby possible to suppress a change in the application caused by a change in the configuration of the component or a change in the mode with the same configuration of the component. It is therefore possible to improve the portability of the application.

### Second Exemplary Embodiment

Another example of the use of the multimedia processing system 100 according to the first exemplary embodiment of the present invention is described hereinafter as a second exemplary embodiment of the present invention. A multimedia processing system 101 according to the second exemplary embodiment of the present invention associates a common component with configuration definition information of a plurality of chain controllers, thereby allowing the common component to perform different operations simply by modifying the configuration definition information. In the following, a difference from the first exemplary embodiment is mainly described, and the same configuration and processing as those in the first exemplary embodiment are not described.

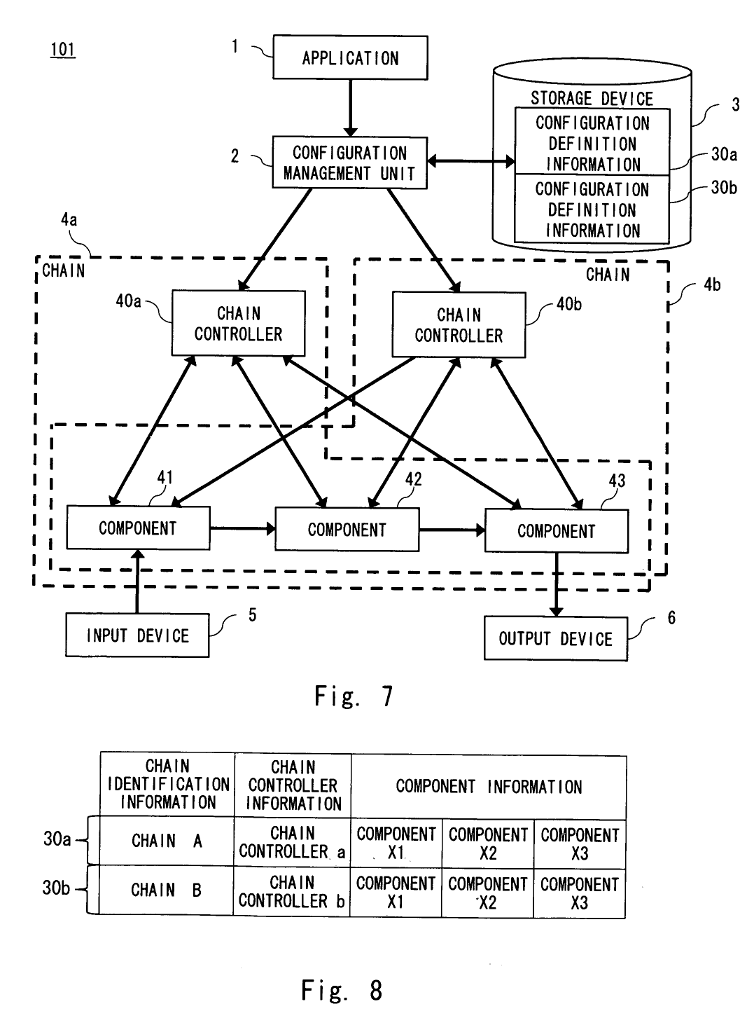

FIG. 7 is a block diagram showing the overall configuration of the multimedia processing system 101 according to the second exemplary embodiment of the present invention. FIG. 8 is a view showing an example of configuration definition information according to the second exemplary embodiment of the present invention. The multimedia processing system 101 shown in FIG. 7 is different from the multimedia processing system 100 shown in FIG. 1 in that the storage device 3 stores configuration definition information 30a and configuration definition information 30b, and that both of a chain controller 40a and a chain controller 40b can control the components 41 to 43.

Referring to FIG. 8, in the configuration definition information 30a, the chain controller 40a and the components 41 to 43 are associated with a chain 4a, and, in the configuration definition information 30b, the chain controller 40b and the components 41 to 43 are associated with a chain 4b.

The chain controller 40a and the chain controller 40b hold information of different modes. For example, the chain controller 40a holds information of modes of MPEG2-PS, Japanese and SD. The chain controller 40b holds information of modes of MPEG2-TS, English and HD.

In this configuration, the application 1 transmits a chain formation instruction containing chain identification information of the chain 4a, the configuration management unit 2 selects the chain controller 40a, and the chain controller 40a sets the mode described above. In this example, the components 41 to 43 can operate as a DVD playback function. Alternatively, the application 1 transmits a chain formation instruction containing chain identification information of the chain 4b, the configuration management unit 2 selects the chain controller 40b, and the chain controller 40b sets the mode described above. In this example, the components 41 to 43 can operate as a DTV reception and playback function.

As described above, in the multimedia processing system 101 according to the second exemplary embodiment of the present invention, a plurality of chain controllers capable of setting different data processing or different modes to the same component can share the same component and allow the component to operate as different multimedia processing functions.

### Third Exemplary Embodiment

An alternative example of the multimedia processing system 100 according to the first exemplary embodiment of the present invention is described hereinafter as a third exemplary embodiment of the present invention. In an multimedia processing system according to the third exemplary embodiment of the present invention, after a resource is allocated to each component or a resource is reserved when connecting components during chain formation processing, the resource is freed according to an instruction from the application.

The application does not always use the function of the chain but is sometimes in the state to perform other processing. In such a state, it is preferred to free a resource or the like for making the chain executable so as to allow use for other purposes.

In light of the above, the configuration management unit according to the third exemplary embodiment receives a connection termination instruction from the application and gives the connection termination instruction for each component to the relevant chain controller, and the chain controller thereby performs connection termination processing of each component. Further, the component according to the third exemplary embodiment can terminate a connection with another component through the control interface. In the following, a difference from the first exemplary embodiment is mainly described, and the same configuration and processing as those in the first exemplary embodiment are not described.

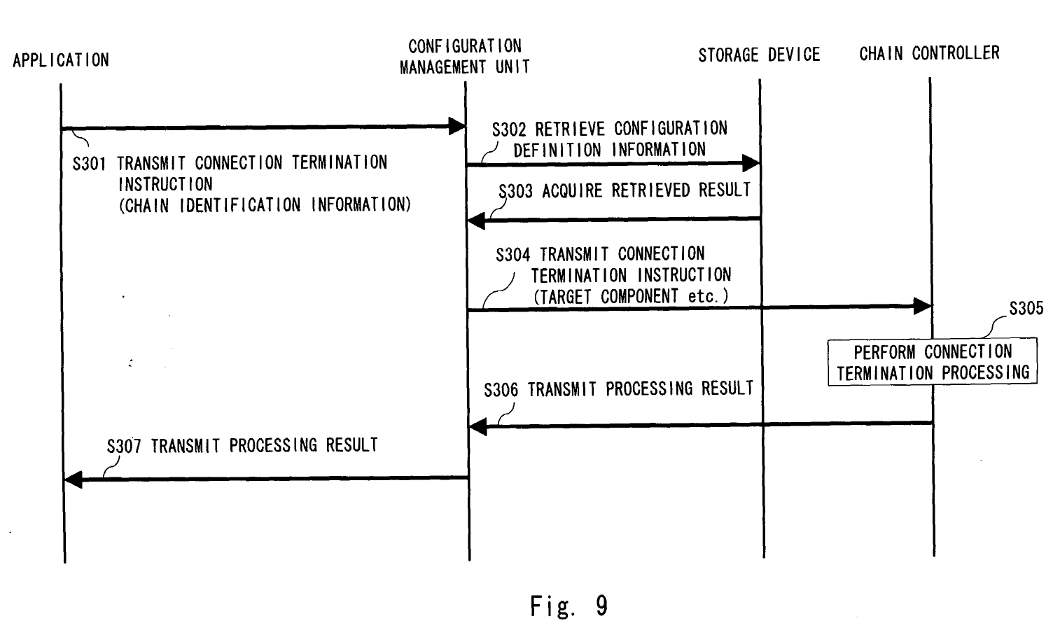

FIG. 9 is a sequence chart of connection termination processing in the multimedia processing system according to the third exemplary embodiment of the present invention. It is assumed in the following that the chain formation instruction according to the first exemplary embodiment is completed.

First, the application 1 transmits a connection termination instruction to the configuration management unit 2 (S301). The connection termination instruction contains chain identification information of the chain 4.

Next, the configuration management unit 2 retrieves the configuration definition information based on the chain identification information contained in the received connection termination instruction (S302) and receives the retrieved configuration definition information 30 (S303), as in the steps S102 and S103 in FIG. 3.

Then, the configuration management unit 2 transmits the connection termination instruction containing component identification information to the chain controller selected in the step S303 (S304). After that, the chain controller 40 performs connection termination processing (S305).

The connection termination processing in the chain controller 40 is performed by transmitting the connection termination instruction to both of the connection origin component and the connection destination component through the control interfaces based on the connection relationship information described above, thereby terminating a connection between the components.

After that, the chain controller 40 transmits a result of the above-described connection termination processing back to the configuration management unit 2 (S306), and the configuration management unit 2 transmits the result of the connection termination processing back to the application 1 (S307), as in the steps S106 and S107 in FIG. 3.

As described above, the multimedia processing system according to the third exemplary embodiment terminates a connection between the components constituting the chain which has been formed based on the instruction from the application and thereby frees the resources allocated to the respective components, thus making an effective use of the resources of the system as a whole.

Although the connection termination instruction is transmitted from the application 1 in the step S301 of FIG. 9, the present invention is not limited thereto. For example, the application 1 may transmit an end request indicating end of processing of the chain. This eliminates the need for the application 1 to be aware of whether to terminate a connection.

### Fourth Exemplary Embodiment

An alternative example of the multimedia processing system 100 according to the first exemplary embodiment of the present invention is described hereinafter as a fourth exemplary embodiment of the present invention. In a multimedia processing system according to the fourth embodiment of the present invention, exclusive control of a chain is performed.

A multimedia processing function by a chain is used by a plurality of applications in some cases. However, it is sometimes unable to concurrently execute a plurality of processing, such as when a component constituting the chain controls particular hardware. In such a case, it is necessary to manage whether the chain is available from the application on the system.

In light of the above, the configuration definition information according to the fourth exemplary embodiment further contains execution state information representing the execution state of a chain and manages the execution state information in association with chain identification information. Then, when receiving a chain formation instruction from the application, the configuration management unit according to the fourth exemplary embodiment refers to the execution state information contained in the corresponding configuration definition information. If the execution state information indicates “being executed”, the configuration management unit according to the fourth exemplary embodiment does not give the chain formation instruction to the chain controller and notifies that to the request source application.

Therefore, if chain formation processing is already performed by any application, when a chain formation instruction is made for the same chain from another application, it is possible to restrict the use of the chain by the application. In the following, a difference from the first exemplary embodiment is mainly described, and the same configuration and processing as those in the first exemplary embodiment are not described.

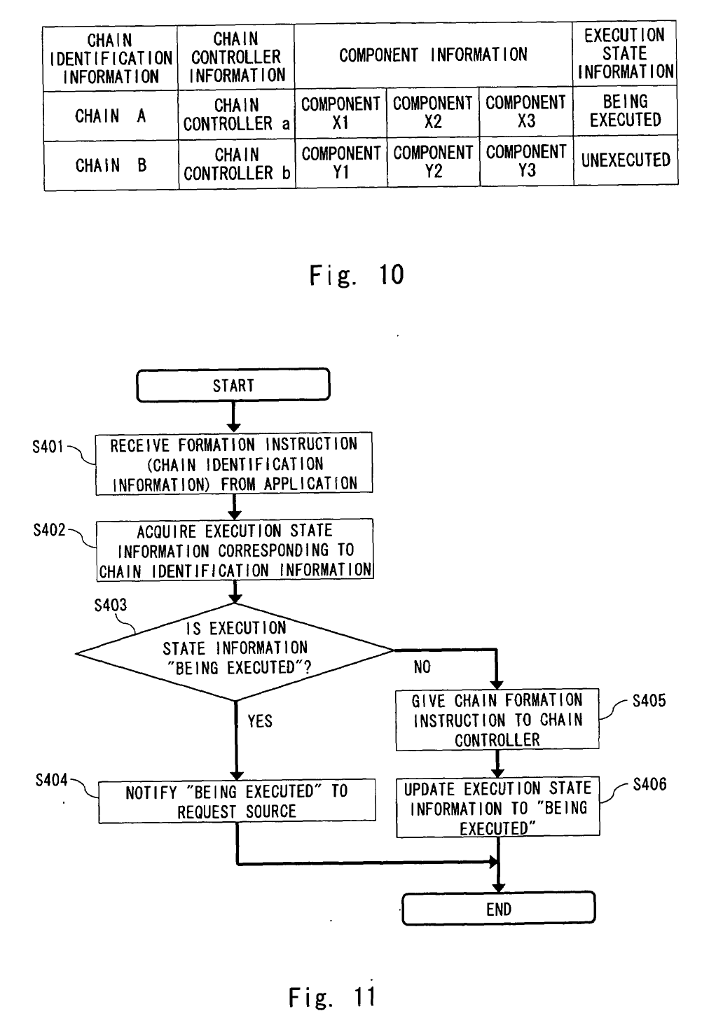

FIG. 10 is a view showing an example of the configuration definition information according to the fourth exemplary embodiment of the present invention. The configuration definition information according to the fourth exemplary embodiment contains execution state information associated with chain identification information. If chain formation processing of the associated chain is completed, the execution state information is contained as information indicating “being executed” in the configuration definition information. On the other hand, if chain formation processing of the associated chain is not yet completed, the execution state information is contained as information indicating “unexecuted” in the configuration definition information. FIG. 10 shows the case where the chain identification information “chain A” is “being executed”.

FIG. 11 is a flowchart of chain exclusive control processing by the configuration management unit according to the fourth exemplary embodiment of the present invention. First, the configuration management unit 2 receives a chain formation instruction containing chain identification information of the chain 4 from the application 1 (S401). The configuration management unit 2 then extracts the chain identification information from the chain formation instruction. Next, the configuration management unit 2 acquires the configuration definition information 30 from the storage device 3 based on the extracted chain identification information (S402).

Then, the configuration management unit 2 determines whether execution state information contained in the acquired configuration definition information 30 is information indicating “being executed” (S403). If it is determined that the execution state information indicates “being executed”, the configuration management unit 2 notifies the request source application 1 that the chain 4 is being executed (S404).

On the other hand, if it is determined that the execution state information does not indicate “being executed”, the configuration management unit 2 transmits the chain formation instruction to the chain controller as in the step S104 of FIG. 3 (S405). Then, the configuration management unit 2 updates the execution state information to “being executed” and stores it into the storage device 3 (S406).

It is thereby possible to restrict the use of the chain by another application.

Although not shown, when the configuration management unit 2 receives a connection termination request according to the third exemplary embodiment from the application 1, it updates execution state information in the configuration definition information specified by the connection termination request to “unexecuted”. This allows another application to use the chain after that.

### Fifth Exemplary Embodiment

An alternative example of the multimedia processing system 100 according to the first exemplary embodiment of the present invention is described hereinafter as a fifth exemplary embodiment of the present invention. A multimedia processing system 102 according to the fifth embodiment of the present invention performs use state management of components.

When there are a plurality of executable chains in the system, the plurality of chains may contain the same component as an element. In such a case, if the component is unable to concurrently perform a plurality of operations because of using a particular hardware function, for example, it is necessary to restrict the use of the component by another chain when a certain chain is using the component.

In light of the above, the multimedia processing system 102 according to the fifth embodiment further includes a component state management unit for managing a use state of each component and a storage device for storing the use state, and the component state management unit inquires about the use state and updates the use state. It is thereby possible to perform exclusive control in units of components. In the following, a difference from the first exemplary embodiment is mainly described, and the same configuration and processing as those in the first exemplary embodiment are not described.

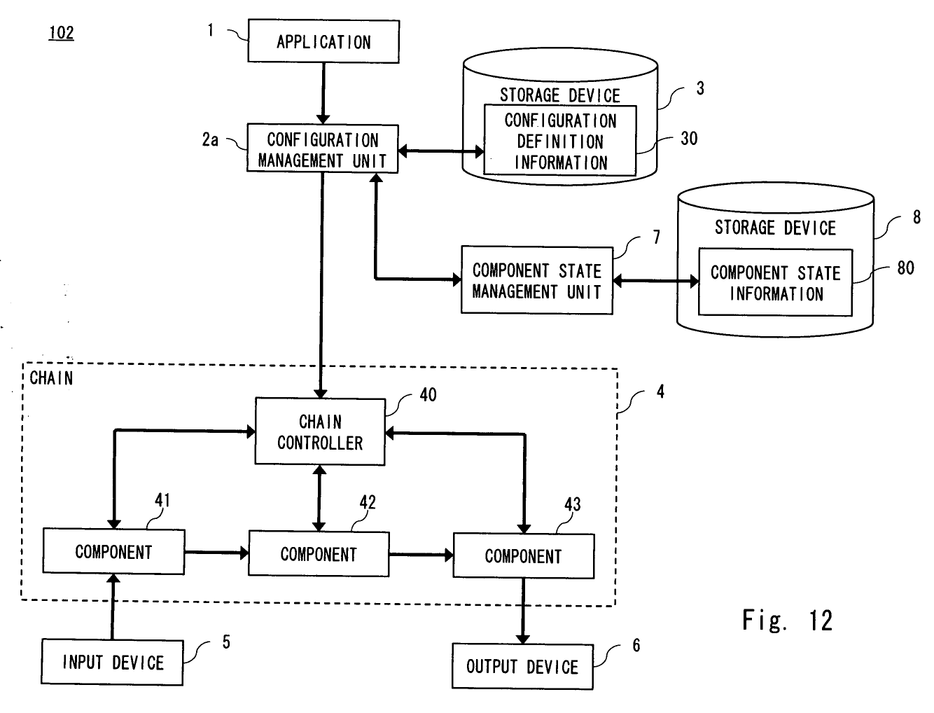

FIG. 12 is a block diagram showing the overall configuration of the multimedia processing system 102 according to the fifth exemplary embodiment of the present invention. In the multimedia processing system 102, a component state management unit 7 and a storage device 8 are added to the configuration shown in FIG. 1, and the configuration management unit 2 is replaced by a configuration management unit 2a.

The storage device 8 stores component state information 80 in which identification information of a component and executability information representing the executability of the component. The storage device 8 may be a nonvolatile storage device such as a hard disk drive, a magneto-optical disk drive or flash memory, or a volatile storage device such as DRAM (Dynamic Random Access Memory).

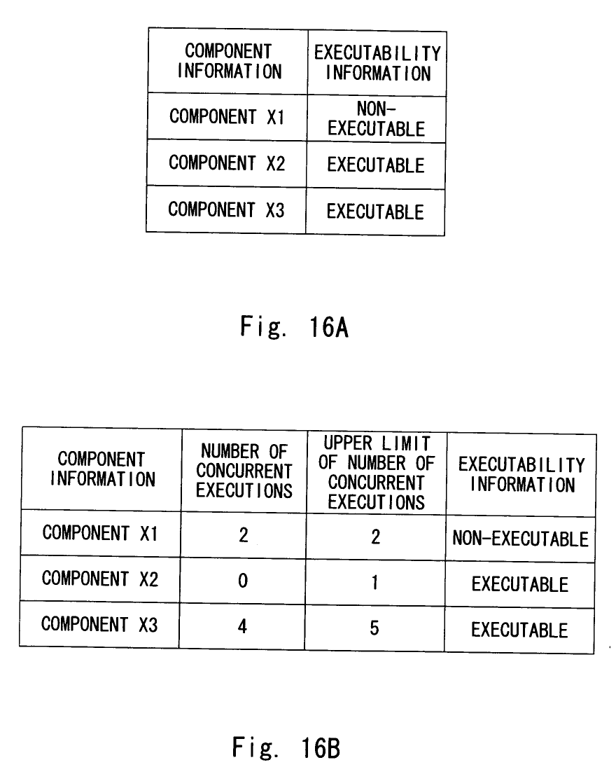

FIG. 16A is a view showing an example of the component state information 80 according to the fifth exemplary embodiment of the present invention. If the relevant component is executable, the executability information is contained as information indicating “executable” in the configuration definition information. On the other hand, if the relevant component is not executable because it is being executed by another component, for example, the executability information is contained as information indicating “non-executable” in the configuration definition information.

Referring back to FIG. 12, the component state management unit 7 is software that refers to the storage device 8 and manages executability information of components. In response to a state inquiry containing component identification information from the configuration management unit 2a, the component state management unit 7 acquires executability information of the relevant component from the component state information 80 and transmits it back to the configuration management unit 2a. Further, in response to a state update request containing component identification information from the configuration management unit 2a, the component state management unit 7 updates executability information of the relevant component and stores it into the storage device 8.

When the configuration management unit 2a receives a chain formation instruction from the application, it refers to the configuration definition information 30 based on chain identification information and acquires component identification information. Then, the configuration management unit 2a transmits a state inquiry containing the component identification information to the component state management unit 7. The configuration management unit 2a can thereby receive executability information and determine the executability of the relevant component. If the received executability information is “non-executable”, the configuration management unit 2a does not give the chain formation instruction to the chain controller and notifies that to the request source application.

On the other hand, if the received executability information is “executable”, the configuration management unit 2a transmits the chain formation instruction to the chain controller and further transmits a state update request for updating the executability information to “non-executable” to the component state management unit 7.

Further, when the configuration management unit 2a receives a connection termination request from the application, it refers to the configuration definition information 30 based on chain identification information and acquires component identification information. Then, the the configuration management unit 2a transmits a state update request for updating the executability information corresponding to the component identification information to “executable” to the component state management unit 7.

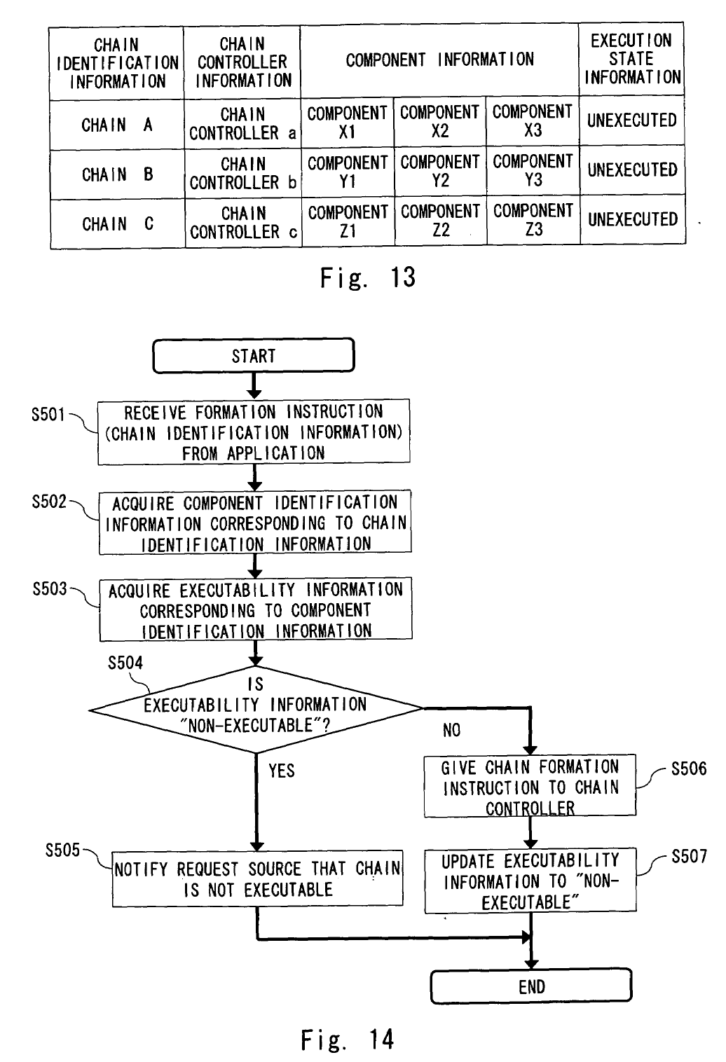

FIG. 13 is a view showing an example of configuration definition information according to the fifth exemplary embodiment of the present invention. In this example, the configuration definition information about three chains is stored. As shown in FIG. 13, the same component information “component X2” belongs to chain identification information “chain A” and chain identification information “chain C”. Thus, “component X2” is associated with a plurality of chains and chain controllers. It is assumed that “component X2” is incapable of concurrent execution.

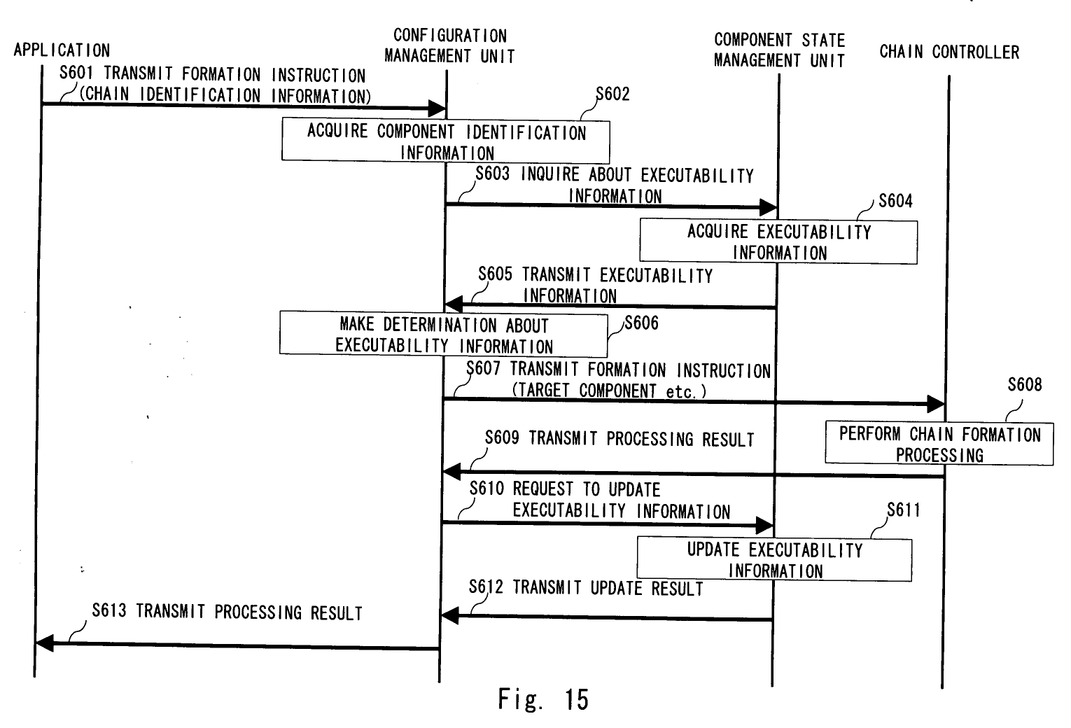

FIG. 14 is a flowchart of component exclusive control processing by the configuration management unit 2a according to the fifth exemplary embodiment of the present invention. In the processing of FIG. 14, a part that is common to the processing of FIG. 11 is not repeatedly described.

First, processing in the step 501 is performed in the same manner as processing in the step 401 of FIG. 11. Next, the configuration management unit 2a acquires component identification information contained in the configuration definition information 30 from the storage device 3 based on the extracted chain identification information (S502).

Then, the configuration management unit 2a acquires executability information corresponding to the component identification information from the component state management unit 7 (S503). The processing in the step S503 is described in detail later with reference to FIG. 15.

Then, the configuration management unit 2a determines whether the executability information represents “non-executable” (S504). If it is determined that the executability information represents “non-executable”, the configuration management unit 2a notifies the request source application 1 that the chain 4 is not executable (S505). Alternatively, the configuration management unit 2a may notify that the chain 4 is being executed, as in the step S404 in FIG. 11.

On the other hand, if it is determined that the executability information does not represent “non-executable”, the configuration management unit 2a transmits the chain formation instruction to the chain controller as in the step S104 of FIG. 3 (S506). Then, the configuration management unit 2a transmits a state update request for updating the executability information to “non-executable” to the component state management unit 7 (S507).

FIG. 15 is a sequence chart of component exclusive control processing in the multimedia processing system according to the fifth exemplary embodiment of the present invention, which shows the case where the executability information represents “executable”. In the processing of FIG. 15, a part that is common to the processing of FIG. 3 is not repeatedly described.

First, processing in the step 601 is performed in the same manner as processing in the step 101 of FIG. 3. Next, processing in the step 602 is performed in the same manner as processing in the step 502 of FIG. 14. Then, the configuration management unit 2a transmits a state inquiry containing the component identification information to the component state management unit 7 (S603).

After that, the component state management unit 7 acquires executability information corresponding to the component identification information received from the configuration management unit 2a from the storage device 8 (S604). Then, the component state management unit 7 transmits the acquired executability information back to the configuration management unit 2a (S605).

Then, the configuration management unit 2a determines whether the received executability information represents “non-executable” as in the step S504 of FIG. 14 (S606). Because it is determined that the executability information does not represent “non-executable” in this example, the process proceeds to the step S506 in FIG. 14 and then chain formation processing is performed in the step S607 to the step S609 in the same manner as in the step S104 to the step S106 in FIG. 3.

After that, the configuration management unit 2a transmits a state update request for updating the executability information to “non-executable” to the component state management unit 7 (S610). Then, the component state management unit 7 receives the state update request containing the component identification information from the configuration management unit 2a, updates the executability information of the relevant component to “non-executable” and stores it into the storage device 8 (S611). Then, the component state management unit 7 transmits the update result back to the configuration management unit 2a (S612). Then, the configuration management unit 2a transmits the result of the chain formation processing back to the application 1 (S613).

Although the component is incapable of concurrent execution in the above example, the present invention is not limited thereto. In the case where the component is capable of concurrent execution up to a prescribed number of times but incapable of concurrent execution exceeding the prescribed number of times, the number of concurrent executions may be further managed in the component state information 80.

FIG. 16B is a view showing an example of the component state information 80 according to the fifth exemplary embodiment of the present invention. The component state information 80 shown in FIG. 16B further includes the number of concurrent executions and the upper limit of the number of concurrent executions in addition to the component state information 80 shown in FIG. 16A. The number of concurrent executions is updated by the component state management unit 7, and the upper limit of the number of concurrent executions is previously set for each component.

In this case, the component state management unit 7 increments or decrements the number of concurrent executions of executability information when updating the executability information, and if the number of concurrent executions is equal to or larger than a prescribed number, it may update the executability information to “non-executable”. This enables application to the case where it is desirable to set a prescribed number as the upper limit of the number of concurrent executions for a component capable of performing concurrent execution in consideration of processing performance or the like. In such a case, the configuration management unit 2a can implement the same processing as in FIG. 14 without any change.

It is thereby possible to control the concurrent execution in units of components when a certain component is associated with a plurality of chains and chain controllers, thereby implementing more secure processing.

### Other Exemplary Embodiments

Although the present invention is applied to the multimedia processing system in the first to fifth exemplary embodiments of the present invention described above, it is not limited thereto. For example, the present invention may be applied to any computer system that implements arbitrary data processing by a plurality of software components.

In the first exemplary embodiment of the present invention, the multimedia processing function may be added or removed by adding or removing the configuration definition information 30. It is thereby possible to set the multimedia processing function that is executable in the system without making a significant modification to the respective software of the application 1, the configuration management unit 2, the chain controller 40 and the components 41 to 43.

Further, the first to fifth exemplary embodiments of the present invention have the advantage that it is possible to perform development of applications and platforms independently or in parallel. The platforms indicate the configuration management unit 2, the configuration management unit 2a, the component state management unit 7, the chain controller 40 and the components 41 to 43 in the first to fifth exemplary embodiments of the present invention described above.

Furthermore, it is preferred that the above-described configuration management unit 2 reads the configuration definition information 30 stored in the storage device 3 into a main storage upon start of a program. It is thereby possible to improve the processing performance of the configuration management unit 2.

The above-described chain controller 40 may perform synchronous processing of processing by a plurality of components. The synchronous processing is such that, in the case of synchronism between a video and audio in a moving picture playback function, for example, the component to process the video and the component to process the audio operate in parallel, and the chain controller 40 synchronizes the components through the respective control interfaces.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A data processing system comprising:
a plurality of components to perform prescribed processing based on an operation mode;
a chain controller to perform control including setting of the operation mode on at least one of the plurality of components;
a storage unit to store chain configuration definition information associating at least one of the plurality of components with the chain controller for each prescribed data processing; and
a configuration management unit to receive a processing request for the prescribed data processing and form a chain corresponding to the requested data processing based on the chain configuration definition information.

2. The data processing system according to claim 1, wherein
the configuration management unit selects the chain controller from the chain configuration definition information corresponding to the prescribed data processing and transmits the processing request for the prescribed data processing to the selected chain controller, and
the chain controller sets the operation mode to at least one of the plurality of components based on the processing request from the configuration management unit and makes the plurality of components operable.

3. The data processing system according to claim 2, wherein
the chain configuration definition information includes component identification information for identifying the plurality of components associated with the prescribed data processing,
the configuration management unit transmits the processing request including the component identification information to the selected chain controller, and
the chain controller sets the operation mode to a component corresponding to the component identification information received from the configuration management unit.

4. The data processing system according to claim 2, wherein
the chain controller allocates resources to the plurality of components and connects the plurality of components based on the processing request.

5. The data processing system according to claim 4, wherein
the configuration management unit receives an end request for the prescribed data processing, selects the chain controller from the chain configuration definition information corresponding to the prescribed data processing and transmits a termination request for terminating a connection between the plurality of components to the selected chain controller, and
the chain controller terminates a connection between the plurality of components based on the termination request from the configuration management unit.

6. The data processing system according to claim 5, wherein
the chain configuration definition information further includes execution state information representing an execution state of the prescribed data processing,
when receiving the processing request for the prescribed data processing, the configuration management unit acquires the execution state information included in the chain configuration definition information corresponding to the prescribed data processing and, if determining that the prescribed data processing is being executed, refrains from transmitting the processing request to the chain controller and transmits a notification that the prescribed data processing is being executed to a request source of the prescribed data processing, and if determining that the prescribed data processing is not being executed, updates the execution state information to represent “being executed” and transmits the processing request to the chain controller, and
when receiving the end request, the configuration management unit acquires the execution state information included in the chain configuration definition information and updates the execution state information to represent “not being executed”.

7. The data processing system according to claim 3, further comprising:
a component state storage unit to store executability information representing executability of the components; and
a component state management unit to manage the executability information of the components by referring to the component state storage unit, wherein
in response to a state inquiry about the component from the configuration management unit, the component state management unit acquires the executability information of the component from the component state storage unit and transmits the executability information back to the configuration management unit, and
in response to a state update request for the component from the configuration management unit, the component state management unit updates the executability information of the component stored in the component state storage unit.

8. The data processing system according to claim 7, wherein
when receiving the processing request for the prescribed data processing, the configuration management unit selects the component identification information included in the chain configuration definition information corresponding to the prescribed data processing and transmits the state inquiry about the component corresponding to the component identification information to the component state management unit,
if the executability information received from the component state management unit represents “non-executable”, the configuration management unit refrains from transmitting the processing request to the chain controller and transmits a notification that the prescribed data processing is not executable back to a request source of the prescribed data processing, and
if the executability information received from the component state management unit represents “executable”, the configuration management unit transmits the processing request to the chain controller and then transmits the state update request for updating the executability information to represent “non-executable” to the component state management unit.

9. The data processing system according to claim 8, wherein
the executability information includes the number of concurrent executions,
when updating the executability information, the component state management unit increments or decrements the number of concurrent executions included in the executability information, and
if the number of concurrent executions is equal to or larger than a prescribed number, the component state management unit updates the executability information to represent “non-executable”.

10. The data processing system according to claim 1, wherein
the chain configuration definition information further includes execution state information representing an execution state of the prescribed data processing, and
when receiving the processing request for the prescribed data processing, the configuration management unit acquires the execution state information included in the chain configuration definition information corresponding to the prescribed data processing and, if determining that the prescribed data processing is being executed, refrains from transmitting the processing request to the chain controller and transmits a notification that the prescribed data processing is being executed to a request source of the prescribed data processing, and if determining that the prescribed data processing is not being executed, updates the execution state information to represent “being executed” and transmits the processing request to the chain controller.

11. A component management method for causing a computer to execute management of a plurality of components to perform prescribed processing based on an operation mode, comprising:
receiving a processing request for prescribed data processing;
reading chain configuration definition information associating at least one of the plurality of components with a chain controller to perform control including setting of the operation mode on at least one of the plurality of components for each prescribed data processing from a storage unit; and
managing a configuration by forming a chain corresponding to the processing request for the prescribed data processing based on the chain configuration definition information.

12. The component management method according to claim 11, wherein
managing a configuration includes selecting the chain controller from the chain configuration definition information corresponding to the prescribed data processing and transmitting the processing request for the prescribed data processing to the selected chain controller, and
the method further includes setting the operation mode to at least one of the plurality of components based on the processing request by the chain controller.

13. The component management method according to claim 12, wherein
managing a configuration includes transmitting the processing request including component identification information for identifying the plurality of components associated with the prescribed data processing to the selected chain controller, and
setting the operation mode sets the operation mode to a component corresponding to the transmitted component identification information.

14. The component management method according to claim 12, wherein
setting the operation mode includes allocating resources to the plurality of components and connecting the plurality of components based on the processing request.

15. The component management method according to claim 14, further comprising:
receiving an end request for the prescribed data processing;
selecting and reading the chain controller from the chain configuration definition information corresponding to the prescribed data processing from the storage unit, and transmitting a termination request for terminating a connection between the plurality of components to the chain controller; and
terminating a connection between the plurality of components based on the termination request by the chain controller.

16. The component management method according to claim 15, further comprising:
after receiving the processing request for the prescribed data processing, reading execution state information representing an execution state of the prescribed data processing included in the chain configuration definition information corresponding to the prescribed data processing from the storage unit;
determining whether the prescribed data processing is being executed based on the execution state information;
if determining that the prescribed data processing is being executed, refraining from transmitting the processing request to the chain controller and transmitting a notification that the prescribed data processing is being executed to a request source of the prescribed data processing;
if determining that the prescribed data processing is not being executed, updating the execution state information to represent “being executed” and transmitting the processing request to the chain controller;
after receiving the end request, reading the execution state information included in the chain configuration definition information from the storage unit; and
updating the execution state information read after receiving the end request to represent “not being executed”.

17. The component management method according to claim 13, further comprising:
in response to a state inquiry about the component, reading executability information of the component from a component state storage unit to store executability information representing executability of the components and transmitting the executability information back to an inquiry source; and
in response to a state update request for the component, updating the executability information of the component stored in the component state storage unit.

18. The component management method according to claim 17, further comprising:
after receiving the processing request for the prescribed data processing, selecting and reading the component identification information included in the chain configuration definition information corresponding to the prescribed data processing from the storage unit;
transmitting the state inquiry about the component corresponding to the component identification information; and
if the executability information received in response to the state inquiry represents “executable”, transmitting the processing request to the chain controller and then transmitting the state update request for updating the executability information to represent “non-executable”.

19. The component management method according to claim 18, further comprising:
when updating the executability information, incrementing or decrementing the number of concurrent executions included in the executability information; and
if the number of concurrent executions is equal to or larger than a prescribed number, updating the executability information to represent “non-executable”.

20. The component management method according to claim 11, further comprising:
after receiving the processing request for the prescribed data processing, reading execution state information representing an execution state of the prescribed data processing included in the chain configuration definition information corresponding to the prescribed data processing from the storage unit;
determining whether the prescribed data processing is being executed based on the execution state information;
if determining that the prescribed data processing is being executed, refraining from transmitting the processing request to the chain controller and transmitting a notification that the prescribed data processing is being executed to a request source of the prescribed data processing; and
if determining that the prescribed data processing is not being executed, updating the execution state information to represent “being executed” and transmitting the processing request to the chain controller.
